(19) United States
(12) Patent Application Publication
(10) Pub. No.: US 2009/0300935 A1
(43) Pub. Date: Dec. 10, 2009

(54) Chamber dryer with uniform treatment parameters

(76) Inventor: Fabio Paron, Galliate (IT)

Correspondence Address: HEDMAN & COSTIGAN P.C., 1185 AVENUE OF THE AMERICAS, NEW YORK, NY, 10036, US

(21) Appl. No.: 11/919,312

(22) PCT Filed: Apr. 25, 2006
(86) PCT No.: PCT/EP2006/004956

§ 371 Date: Feb. 29, 2008

(30) Foreign Application Priority Data
Apr. 29, 2005 (IT) MI2005A000778

(51) Int. Cl. F26B 25/00

(52) U.S. Cl. 34/236

(57) ABSTRACT

A chamber dryer with uniform treatment parameters comprises a drying chamber (20), a feeding (21) of a mass of damp material to be treated (11), an inlet (25) for a mixture of hot gases, an outlet (26) for a portion of heavy dried material (12) and an outlet (27) for conveyor air, wherein the drying chamber (20) is a fixed chamber comprising at least one conveyor bed (23) of the damp material to be treated consisting of a series of adjacent rotating elements (24) having an adjustable interaxis, in which two adjacent rotating elements define a gaugable passage opening (40).

The present invention relates to a chamber dryer with uniform treatment parameters.

Wood particles or other particles of a vegetal or non-vegetal origin are treated in dryers in order to reduce the humidity from oscillating initial values, for example, from 20% to 150% to values close to 0% if desired.

Types of existing particle dryers consist of belt dryers or, fluid bed dryers, for example for cereals or similar products, in which the material is laid and advances on the belt or bed and is immersed in hot gases.

Dryers with indirect heat exchange envisage the use of tubes with steam, or circulations of hot fumes.

Finally, rotating drum dryers, or dryers with inner rotation and a fixed drum are commonly used, comprising an extremely large drum, in which the material to be treated is introduced together with hot air.

The drawbacks of dryers of the known type relate, as far as conveyor belt dryers are concerned, to the limited movement of the material which consequently substantially exposes the same sides towards the hot air and resting surface respectively. This results in a poor drying efficiency as the heat transfer takes place by pure contact between the heated metallic part and the material to be dried.

In drum dryer, which on the other hand move the material, the drying efficiency is jeopardized by the fact that at one end there is the inlet of damp material and hot air and at the opposite end the dried material and damp air are discharged. The functioning conditions therefore are not constant in all the sections of the drum. In the last treatment areas, in fact, the air in contact with the material is already charged with humidity.

Furthermore, drum dryers have high plant and maintenance costs.

An objective of the present invention is to provide a high-efficiency chamber dryer with uniform treatment parameters.

A further objective of the present invention is to provide a chamber dryer with uniform treatment parameters having reduced dimensions in relation to the drying capacities.

Another objective of the present invention is to provide a chamber dryer with uniform treatment parameters which allows a rapid modification of the production parameters.

Yet another objective of the present invention is to provide a chamber dryer with uniform treatment parameters which is particularly simple and functional, with limited costs.

These objectives according to the present invention are achieved by providing a chamber dryer with uniform treatment parameters as specified in claim 1.

Further characteristics are indicated in the dependent claims.

The characteristics and advantages of a chamber dryer with uniform treatment parameters according to the present invention will appear more evident from the following illustrative and non-limiting description, referring to the enclosed schematic drawings, in which:

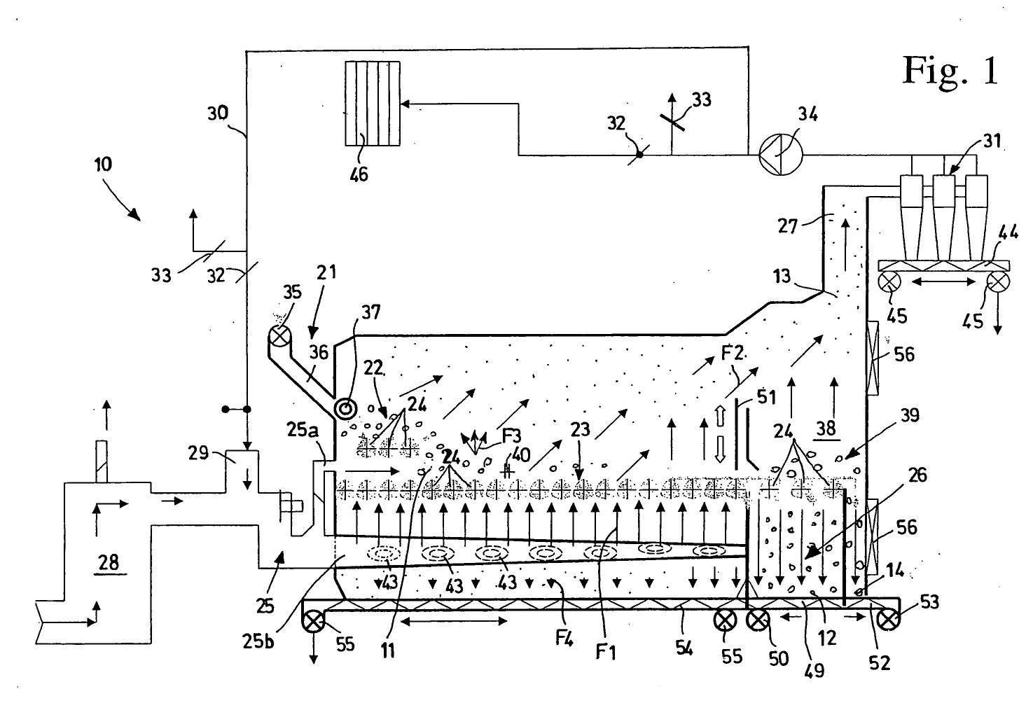

FIG. 1 is a schematic side view of a chamber dryer with uniform treatment parameters, according to the present invention;

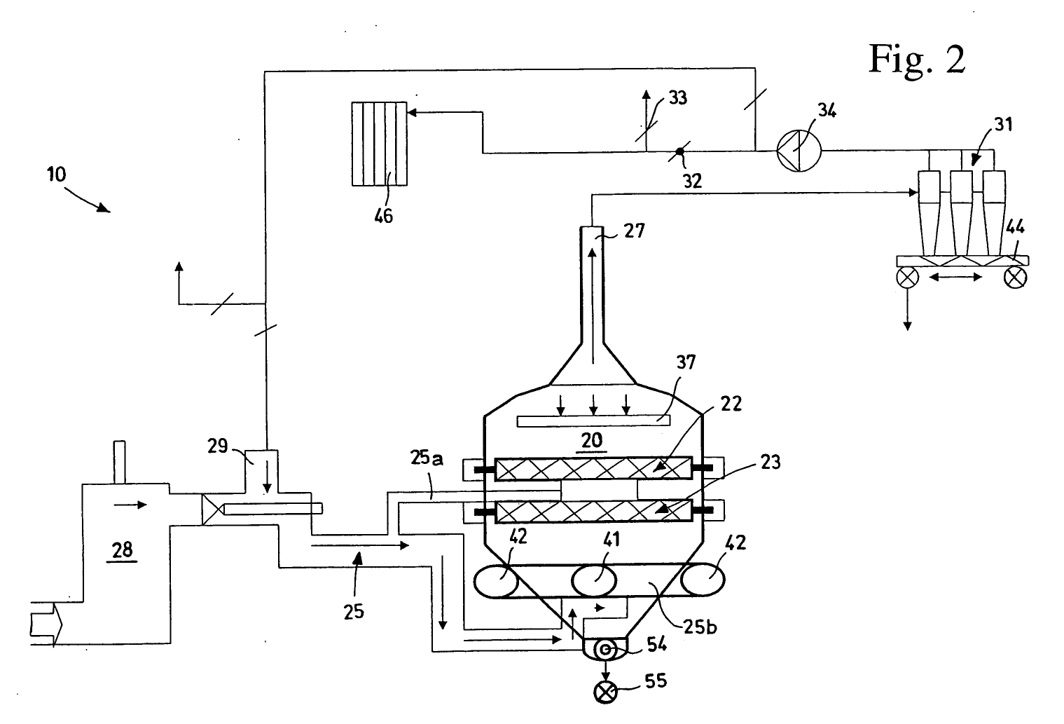

FIG. 2 schematically shows the dryer of FIG. 1 from a short side;

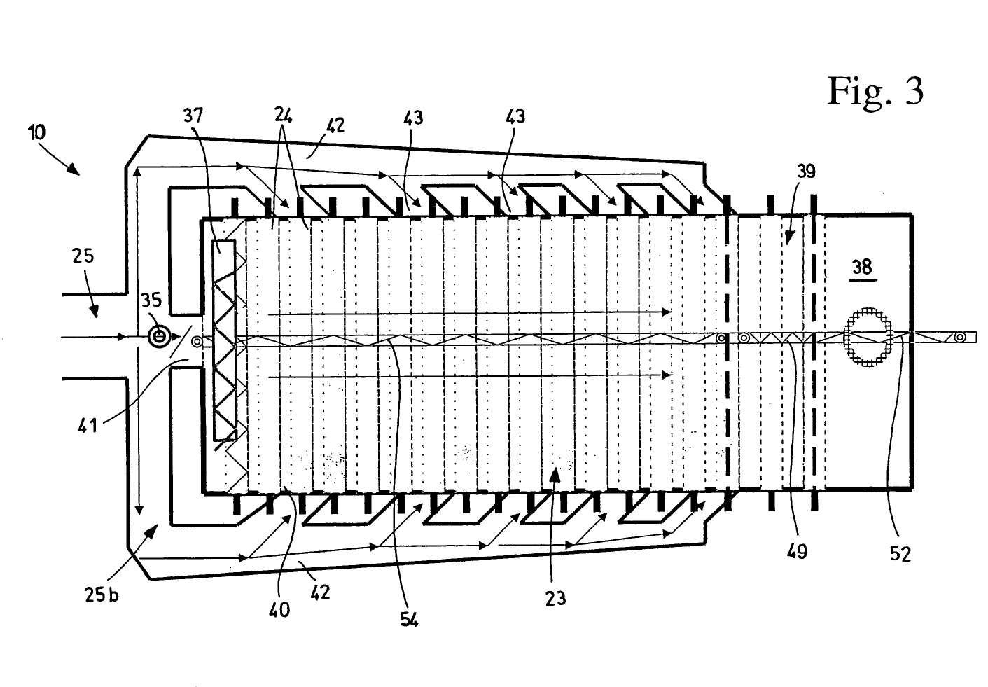

FIG. 3 is a schematic plan view of a drying and decanting chamber of the chamber dryer with uniform treatment parameters according to the present invention.

With reference to the figures, these show a chamber dryer with uniform treatment parameters, indicated as a whole with 10, comprising a fixed drying chamber 20 equipped with a feeding 21 of a mass of damp material to be treated 11, a first impact and distribution bed 22, a second lifting and conveyor bed 23, consisting of a series of rotating elements 24, inlet ducts 25 for a mixture of hot gases fed in equicurrent with the material 11 to be treated, an outlet 26 for a portion of heavy dried material 12 and an outlet duct 27 for a portion of fine material 13 and conveyor air.

The hot gases are produced in a combustion chamber 28, situated upstream of the drying chamber 20, by means of a burner functioning with natural gas and sawdust of the known type, not shown.

The temperature of the hot gases coming from the combustion chamber 28 reaches the desired drying temperature in a mixing chamber 29 with a horizontal inlet. In relation to the humidity and quantity of particles to be treated fed to the drying chamber 20, a part of the mixture of hot gases and steam, separated in a series of cyclones 31 downstream of the drying chamber 20, is introduced into the mixing chamber 29 in a tangential direction by means of a recovery pipe 30.

The recovery pipe 30, as schematically shown in FIG. 1, is provided with regulation shutters 32 and an emergency stack 33, which, when activated by a specific shutter, in the case of necessity, stops the flow of hot gases returning towards the mixing chamber 29 moved by a main fan 34.

The damp particles 11 to be treated, purified as much as possible of all kinds of foreign bodies by means of already known separation systems, such as an omega pre-dryer, not shown, are introduced into the drying chamber 20, by a stellar sealing valve 35 and through a channeling 36 they drop into a distribution Archimedean screw with an adjustable bottom 37, whose function is to regularly distribute the arriving flow of material 11 over the whole width of the first impact and distribution bed 22.

The rotating elements 24, with which the material fed 11 comes into contact, which are sturdily built and have an adjustable interaxis, allow the particles to drop in a diversified manner onto the second lifting and conveyor bed 23, situated below, depositing the material in the drying phase in a thin and uniform layer.

The rotating conveying elements 24 have a geometry which contributes to lifting the material while it is being transported into the drying chamber 20 towards a decanting chamber 38.

The conveyor bed 23, which longitudinally crosses the whole drying chamber 20 can have a horizontal or tilting position. The conveyor bed 23 moves the material to be treated 11 from the Archimedean feed screw 37 to the outlet 26 of the dryer 10 and, in the case of an emergency, allows the rapid emptying of the drying body with a low electric energy consumption.

A third bed for the separation 39 of a gross portion 14 of material is situated downstream of the conveyor bed 23 in a first section of the decanting chamber 38. The rotating elements 24 are situated at a suitable distance for the purpose so as to allow the direct falling of the dried material 12 with lesser dimensions to a desired passage opening 40, or free section, positioned between two successive elements and advance the material with greater dimensions 14 in a second section of the decanting chamber 38, in which it is rejected for subsequent processing or selection, avoiding translation through other parts of the plant.

The rotating elements 24 of the distribution bed 22, the conveyor bed 23 and the separation bed 39 preferably, but not necessarily, have a cam profile, as shown in FIG. 1. The rotating elements 24 can have a trilobite, quadrilobite form, or they can be conformed as circular section rolls, possible eccentric. The rotating elements 24 can also be modular, suitably phased with each other.

The distance between the rotating elements 24 can be regulated and the passage opening 40, or free section, situated between two successive elements 24 has a converging-diverging form with a geometry cyclically varying in a transversal section plane.

The inlet ducts 25 for the mixture of hot gases comprise a specific channeling 25a which introduces a flow of hot gases between the distribution bed 22 and the conveyor bed 23. By keeping the lighter particles and powders 13 in suspension, it effects their immediate drying, allowing them to be evacuated without being deposited on the metallic parts heated by the drying gas.

A further branched channeling 25b also allows the inlet of dry air at a constant temperature into the drying chamber in a position underlying the conveyor bed 23.

The branched channeling 25b comprises a first central duct 41 centrally entering the end of the drying chamber 20, as shown in FIGS. 2 and 3. Side ducts 42 arranged on the opposite sides of the drying chamber 20 have a series of mouths 43 with a section progressively decreasing on the sides of the drying chamber 20 in order to maintain a constant rate and pressure of the drying air along the whole drying chamber 20 below the conveyor bed 23.

During the drying, the material 11 is always crossed and therefore treated by saturated dry air at a constant temperature and with a perpendicular direction with respect to the advance direction of the material, as schematically indicated by the arrows F1 of FIG. 1. The drying is consequently effected by contact of the particles with the hot gases which collide with the particles themselves and not by contact with hot metallic parts.

The drying chamber 20 therefore has an area in depression below the conveyor bed 23 and an area in depression above it.

The mixture of hot gases, steam and lighter particles in suspension in the upper part of the chamber is sucked according to the direction indicated by the arrows F2 by the main fan 34 through the specific outlet duct 27 and separation cyclones 31, which decant the larger-sized powders in a reversible extraction Archimedean screw 44 situated on the bottom of the cyclones themselves 31, subsequently discharging them through specific stellar valves 45.

The mixture of hot gases, steam and powders separated in the set of cyclones 31, is sent to the main fan 34 in a purifier 46 on whose line there is an emergency stack 33 and a safety shutter 32.

Due to the low velocity of the gases in the drying chamber, the heaviest particles which are deposited on the rotating conveying elements 24, are relifted and thrown upwards and towards the decanting chamber 38, according to the arrows F3. The particles advance, moreover, as they fall, also pushed by the stream of gas which passes through the passage openings 40 between the rotating elements 24.

The volume of the decanting chamber 38 is dimensioned so as to drastically lower the air rate and allow the dried material 12 to drop onto an extraction Archimedean screw 49 situated on the bottom of the chamber itself 38 and be discharged through outlet stellar valves 50. An adjustable motorized shutter 51 allows the air rate to be calibrated in the decanting chamber 38.

The gross portion 14 is discharged downstream of the decanting chamber 38 by means of an Archimedean screw 52, through a stellar valve 53.

The finer particles which, during their passage through the drying chamber 20 have passed into the free section 40 between the adjacent rotating elements 24 according to the arrows F4 due, for example, to the sudden lack of pressure, fall onto a reversible extraction Archimedean screw 54 situated on the bottom of the drying chamber 20 and are discharged through specific stellar valves 55 to be re-admitted into the treatment cycle.

The residence time of the material inside the drying chamber 20 is determined by the rotation rate of the rotating elements 24 and also the velocity of the hot gases moved by the main fan 34.

The particles 11 remain in the drying chamber 20 for a time which is directly proportional to their weight and inversely proportional to their surface. At the outlet of the decanting chamber 38 a humidity degree equal to 1.5÷2% is reached, in relation to the temperature of the outgoing gases. This temperature is kept constant by the automatic modulation of the burner.

The dehumidification treatment in vertical increases the efficiency of the dryer 10 as the air which is saturated with humidity is sucked from above without re-passing through other material in the process phase.

The flow of dry air coming from the combustion chamber 28, passes through the free section 40 between the adjacent rotating elements 24, reaching the maximum velocity in the minimum free section between the rotating elements 24. This causes an increase in the thermal efficiency, due to a well-known aerodynamic effect, whereby the passage of air in narrow sections increases the dissipative effect transforming the kinetic energy of the fluid stream into heat during the subsequent expansion phase.

Furthermore, the flow of saturated dry air, expanding after the minimum section generates an air cushion which increases the agitation of the material caused by the movement of the rotating elements, keeping it in suspension and exposing the whole of its surface to the drying treatment.

The spark detectors, temperature and pressure, water-spraying valves and regulation and emergency shutters, as well as the explosion-preventing gates 56 allow the safe functioning of the plant and a constant maintenance of the humidity values on the dried product.

The chamber dryer with uniform treatment parameters, object of the present invention, has the advantage of having modular dimensions in relation to the drying capacities and assembly facilitated by the possibility of preassembly, together with simple running and maintenance.

Production parameters, such as the temperature, humidity at the outlet, volume of material treated, and others are, moreover, data that can be rapidly modified due to the low inertia of the system.

In the case of emergency, the rotating elements which move the material from the inlet to the outlet of the dryer, advantageously allow a rapid emptying of the drying body with a low electric energy consumption.

The dryer, object of the present invention, has the advantage that, during drying, the material is always crossed and therefore treated by saturated dry air at a constant temperature and with a perpendicular direction with respect to the advance direction of the material.

The characteristics of the drying fluid inside the drying chamber upstream of the rolls are advantageously constant in each transversal section of the machine.

Furthermore, the dehumidification treatment in vertical ensures the efficiency of the dryer itself as the air which is saturated with humidity is sucked from above without re-passing through other material in the processing phase.

The flow of dry air coming from the combustion chamber, passing through the free section between the adjacent rotating elements having a converging-diverging form advantageously increases the thermal efficiency due to the dissipative effect, transforming the kinetic energy of the fluid stream into heat during the subsequent expansion phase, and also the movement of the material.

In the chamber dryer with uniform treatment parameters, the drying advantageously takes place by contact of the particles with the hot gases which collide with the particles themselves and not by contact of the particles with hot metallic parts, i.e. by indirect thermal exchange.

The chamber dryer with uniform treatment parameters thus conceived can undergo numerous modifications and variations, all included in the invention; furthermore, the details can be substituted by technically equivalent elements. In practice, the materials used, as also the dimensions, can vary according to the technical requirements.

1. A chamber dryer with uniform treatment parameters comprising a drying chamber (20), a feeding (21) of a mass of damp material to be treated (11), an inlet (25) for a mixture of hot gases, an outlet (26) for a portion of heavy dried material (12) and an outlet (27) for conveyor air, characterized in that the drying chamber (20) is a fixed chamber comprising at least one conveyor bed (23) of said damp material to be treated consisting of a series of adjacent rotating elements (24) having an adjustable interaxis, in which two adjacent rotating elements define a gaugable passage opening (40).

2. The dryer according to claim 1, characterized in that said drying chamber (20) comprises a further impact and distribution bed (22) of said damp material to be treated (11), said bed (22) comprising adjacent rotating elements (24) and being situated above said conveyor bed (23) in correspondence with said feeding (21).

3. The dryer according to claim 1, characterized in that said conveyor bed (23) longitudinally crosses said drying chamber (20) from said feeding (21) to a decanting chamber (38) close to said outlet (26) of the heavy dried material (12).

4. The dryer according to claim 1, characterized in that said conveyor bed (23) can have a horizontal or tilting position.

5. The dryer according to claim 1, characterized in that said feeding (21) of said mass of damp material to be treated (11) comprises a stellar sealing valve (35) and a distribution Archimedean screw with and adjustable bottom (37).

6. The dryer according to claim 3, characterized in that it comprises a bed for the separation (39) of a gross portion (14) of material situated downstream of said conveyor bed (23) above a first section of said decanting chamber (38), a second section of said decanting chamber (38) collecting said gross portion (14) of treated material having dimensions greater than passage openings (40) between rotating elements (24) of said separation bed (39).

7. The dryer according to claim 6, characterized in that said first section of said decanting chamber (38) is equipped on the bottom with an extraction Archimedean screw (49) of heavy dried material (12).

8. The dryer according to claim 6, characterized in that said second section of said decanting chamber (38) comprises an extraction Archimedean screw (52) of the discarded gross portion (14).

9. The dryer according to claim 6, characterized in that it comprises an adjustable motorized shutter (51) for calibrating the air rate in the decanting chamber (38).

10. The dryer according to claim 1, characterized in that said drying chamber (20) comprises a reversible extraction Archimedean screw (54) in a position underlying said conveyor bed (23) for collecting fine particles through said passage openings (40) between said rotating elements (24).

11. The dryer according to claim 1, characterized in that said rotating elements (24) have a cam profile, said passage opening (40) between two adjacent rotating elements (24) having a converging-diverging form with a geometry which is cyclically variable on a plane with a transversal section.

12. The dryer according to claim 2, characterized in that said inlet (25) for a mixture of hot gases comprises a first channeling (25a) for the entry of gas between said distribution bed (22) and said conveyor bed (23).

13. The dryer according to claim 1, characterized in that said inlet (25) for a mixture of hot gases comprises a branched channeling (25b) for the entry of gas below said conveyor bed (23).

14. The dryer according to claim 13, characterized in that said branched channeling (25b) comprises a first central inlet duct (41) at the end of said drying chamber (20) and side ducts (42) situated on opposite sides of said drying chamber (20) equipped with a series of mouths (43) having a progressively decreasing section on the sides of the drying chamber (20), suitable for maintaining a constant drying air rate and pressure along the whole drying chamber (20) below said conveyor bed (23).

15. The dryer according to claim 1, characterized in that, upstream of said drying chamber (20), it comprises a combustion chamber (28) for the production of hot gases and a mixing chamber (29) for their mixing with the recovered gases separated in a set of cyclones (31) positioned downstream of said drying chamber (20), said recovered gases being moved by a fan (34) in a recovery pipe (30).

16. The dryer according to claim 15, characterized in that said recovery pipe (30) is equipped with regulation shutters (32) and an emergency stack (33).

17. The dryer according to claim 1, characterized in that said set of cyclones (31) comprises an extraction Archimedean screw (44) of a part of the powders and stellar valves for their discharge
